(19) United States
(12) Patent Application Publication
(10) Pub. No.: US 2006/0048139 A1
(43) Pub. Date: Mar. 2, 2006

(54) Uninstallation processing program and uninstallation management program

(75) Inventor: Yumiko Nakamura, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/024,758

(22) Filed: Dec. 30, 2004

(30) Foreign Application Priority Data
Aug. 30, 2004 (JP) 2004-250740

(51) Int. Cl. G06F 9/445

(52) U.S. Cl. 717/174

(57) ABSTRACT

To provide a technique which can offer services intended for convenience of users on computers provided with preinstalled application programs, the technique includes: measuring the execution frequency of an application program for each of application programs executed by a computer 100; displaying a measured execution frequency for each of the application programs; requesting for an input which specifies an instruction whether to uninstall a displayed application program or not; obtaining information which can identifies the computer 100 and is stored on a storage area of the computer 100 upon receiving the input of the instruction on uninstallation of any of the application programs; transmitting the information used for identifying the application programs to be uninstalled and information used for identifying the computer 100 to a server 200; receiving information on permission for the uninstallation from the server 200; uninstalling the application programs; and storing uninstallation information indicating that the application programs have been uninstalled onto the storage area.

### BACKGROUND OF THE INVENTION

The present invention relates to a management technology for application programs executed by a computer.

Computers used by general users have application programs used for executing various processing installed thereon. Especially, personal computers currently available on the market have a large number of application programs installed (preinstalled) thereon in advance.

It should be noted that prior arts relating to the present invention of the application include technologies disclosed in the following Patent documents 1 to 5, for example.

[Patent Document 1]

Japanese Patent Application Laid-Open Publication No.2000-112717

[Patent Document 2]

Japanese Patent Application Laid-Open Publication No.09-231148

[Patent Document 3]

Japanese Patent Application Laid-Open Publication No.2002-163505

[Patent Document 4]

Japanese Patent Application Laid-Open Publication No.09-212341

[Patent Document 5]

Japanese Patent Application Laid-Open Publication No.2003-58764

### SUMMARY OF THE INVENTION

However, application programs unnecessary for a user may be installed on the computer provided with preinstalled programs. In this case, the user may think that many preinstalled application programs unduly increase the price.

In addition, the computer having the many preinstalled application programs needs such a storage capacity on a secondary storage device such as a hard disk as to correspond to the data quantity of these application programs. In this case, the user may not be satisfied that the storage capacity on the hard disk is consumed by the unnecessary application programs.

The present invention is devised in view of the problems described above. That is, it is an object of the present invention to provide a technology which can offer services intended for convenience of users on computers provided with preinstalled application programs.

To solve the above-mentioned problems, the present invention adopts the following means. That is, the present invention may be specified as a transmission apparatus, including: measuring the execution frequency of an application program for each of application programs executed by a computer; displaying a measured execution frequency of each of the application programs; transmitting the information used for identifying the application programs to be uninstalled, and information used for identifying the computer, to a server; receiving information on permission for the uninstallation, from the server; uninstalling the application programs; and storing uninstallation information indicating that the application programs have been uninstalled onto the storage area. Further, the present invention may include the step of: requesting for an input which specifies an instruction whether to uninstall the displayed application programs or not; and obtaining information which can identifies the computer and is stored on a storage area of the computer upon receiving the input of the instruction of uninstallation on any of the application programs.

According to the present invention, the execution frequencies of the application programs are displayed to the user. In addition, according to the present invention, it is proposed that the user refers to the execution frequencies to delete unnecessary application programs. Then, according to the present invention, points corresponding to the deleted application programs are provided to allow exchange for another article.

Therefore, according to the present invention, the services intended for the convenience of users can be offered on the computers provided with preinstalled application programs.

Further, the present invention is characterized by making it impossible to execute reinstallation of the application program whose uninstallation information is stored on the storage area.

Thus, according to the present invention, the application programs for which the uninstallation processing has been carried out can be prevented from being reinstalled.

Further, the present invention is characterized in that the storage area is at least one of an EP-ROM area and a registry area of the computer.

According to the present invention, the information relating to the uninstallation processing is stored on a storage area of the computer which is hard to be rewritten.

Therefore, according to the present invention, it is possible to effectively manage the uninstallation processing.

Further, the present invention is characterized by including: receiving information used for identifying a computer and information used for identifying an application program to be uninstalled from the computer; transmitting information on permission for the uninstallation based on the information used for identifying the application program to be uninstalled, to the computer; and storing the information used for identifying the computer and information on the uninstalled application program.

According to the present invention, information used for identifying a computer and information relating to uninstallation processing are received from the computer. Then, according to the present invention, information on application programs for which the uninstallation processing has been carried out is stored.

Therefore, according to the present invention, the services intended for the convenience of users can be offered on the computers provided with preinstalled application programs. Additionally, according to the present invention, it is possible to effectively manage the uninstallation processing.

Further, the present invention is characterized by including: calculating point information assigned to the computer based on the information used for identifying the application program to be uninstalled; transmitting the point information to the computer; transmitting information on an article purchasable based on the point information to the computer; receiving purchase request information on the article based on the point information from the computer; transmitting the article corresponding to the purchase request information to the computer; and transmitting point information after purchasing article, to the computer.

According to the present invention, points are assigned to the computer according to the uninstallation processing.

Therefore, according to the present invention, the point-assignment service intended for the convenience of users can be offered on the computers provided with preinstalled application programs.

As described above, according to the present invention, it is possible to provide the technology which can offer the services intended for the convenience of users on the computers provided with preinstalled application programs.

### DESCRIPTION OF THE DRAWINGS

FIG. 1 is a schematic diagram showing a configuration of a system to which an uninstallation processing program and an uninstallation management program according to a present embodiment are applied;

FIG. 2 is a block diagram showing functions realized by a computer;

FIG. 3 is a block diagram showing functions realized by a maker server;

FIG. 4 is a diagram showing an example of information on preinstalled programs of the computer of a user stored on a database;

FIG. 5A and FIG. 5B are flowcharts of uninstallation processing according to the system;

FIG. 6A and FIG. 6B are flowcharts of the uninstallation processing according to the system;

FIG. 7 is a ranking screen showing usage rates of all of application programs;

FIG. 8 is a ranking screen showing a state where the user has instructed the uninstallation processing; and

FIG. 9 is an illustration showing an example of information on the computer notified from the computer to the maker server.

### DETAILED DESCRIPTION OF THE INVENTION

A description will now be given of the best mode of carrying out the present invention with reference to drawings. The configuration of the following embodiment is described merely by way of example, and thus, the present invention is not limited to the embodiment.

<System Configuration>

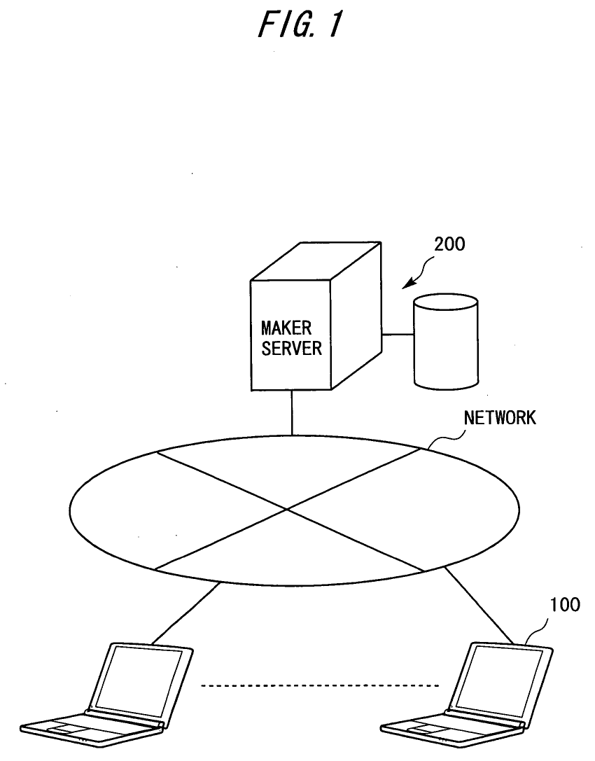

FIG. 1 is a schematic diagram showing the configuration of a system to which an uninstallation processing program and an uninstallation management program according to the embodiment are applied. If application programs preinstalled on a computer are uninstalled, the system according to the embodiment assigns points to a user according to the uninstalled application programs. In the system, the user can then use the points in order to purchase new articles and the like.

In FIG. 1, computers 100 used by users and a server 200 of a maker which sells the computers 100 are connected to a network constituting the system. The computers 100 have the uninstallation processing program according to the present invention introduced (installed) thereon. In addition, the maker server 200 has the uninstallation management program according to the present invention introduced thereon.

Used as the computer 100 is a personal computer (PC) A personal digital assistant (PDA), and other dedicated computer. Note that a description will be given assuming that the computer 100 is primarily a personal computer in the embodiment. The computer 100 is provided with a control device (constituted by a CPU, a main memory (such as a RAM), an input/output unit, an OS, device drivers, etc.), a secondary memory (such as a hard disk), and a communication control device (such as a network interface device) as hardware which is not shown. The CPU loads the uninstallation processing program stored on the secondary memory onto the main memory, and executes the program, and as a consequence, the computer 100 realizes functions of the computer which can offer the uninstallation processing in the system.

Used as the maker server 200 is a personal computer (PC) a server, and other dedicated computer. The maker server 200 is provided with a control device (constituted by a CPU, a main memory (such as a RAM), an input/output unit, an OS, and device drivers), a secondary memory (such as a hard disk), and a communication control device (such as a network interface device) as hardware which is not shown. The CPU loads the uninstallation management program stored on the secondary memory onto the main memory, and executes the program, and as a consequence, the maker server 200 realizes functions of the uninstallation management processing in the system.

<Configuration of Devices>

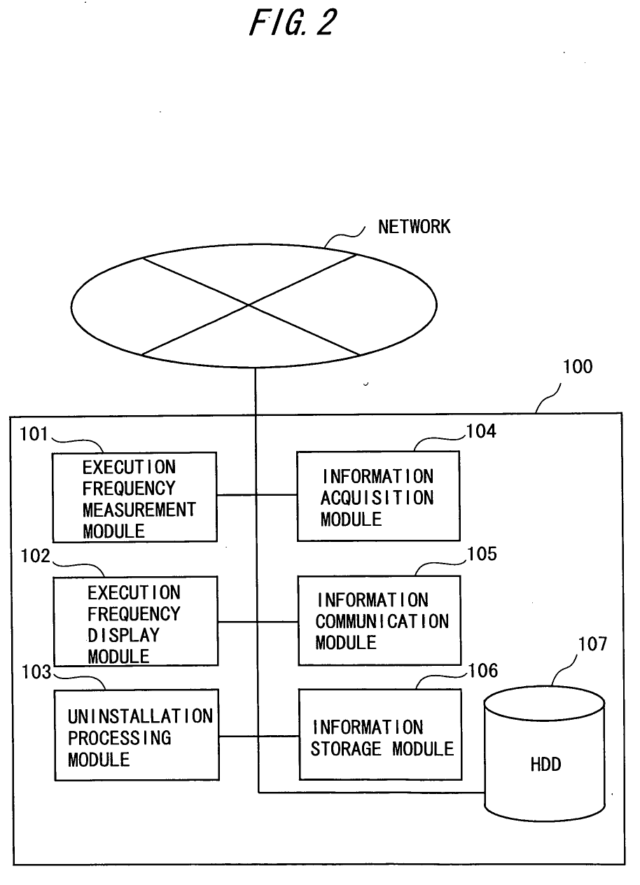

FIG. 2 is a block diagram showing the functions realized by the computer 100. The uninstallation processing program provides the computer 100 with an execution frequency measurement module 101, an execution frequency display module 102, an uninstallation processing module 103, an information acquisition module 104, an information communication module 105, an information storage module 106, and a database 107.

The execution frequency measurement module 101 measures the execution frequencies of respective application programs, which were installed on delivery from the factory (refereed to as preinstalled programs hereinafter), of application programs executed by the computer 100. The execution frequency measurement module 101 starts measuring the execution frequencies from a first startup after the computer 100 is delivered to a user. In addition, the execution frequency measurement module 101 summarizes the execution frequencies of all the preinstalled programs after an predetermined period has elapsed from the start of the measurement of the execution frequencies (one month later, for example).

The execution frequency display module 102 displays the execution frequencies after the predetermined period of the preinstalled programs summarized by the execution frequency measurement module 101 on a display (not shown) of the computer 100.

The uninstallation processing module 103 provides functions of an uninstallation processing module and an uninstallation lock processing module of the computer according to the present invention. The uninstallation processing module 103 carries out the uninstallation processing of the preinstalled programs from the hard disk of the computer 100 based on an instruction of the user. On this occasion, the user refers to the execution frequencies of the preinstalled programs shown on the display, thereby instructing the uninstallation from input means (such as a mouse and a keyboard).

The information acquisition module 104 acquires information which can identify the computer 100, and was stored onto the computer 100 in advance. This identifying information includes a serial number (production number) and a model symbol (model name) specified by the maker of the computer 100. Note that it is desirable to write the information which can identify the computer 100 onto an area, which is hard to be tampered by the user and the like, in the storage area of the computer 100. Such storage area may be an EP-ROM area or a registry area of the computer 100, for example.

The information communication module 105 communicates information relating to the uninstallation processing with the maker server 200. The information transmitted from the information communication module 105 to the maker sever 200 includes the information which can identify the computer 100 such as the serial number and the model symbol, and information requesting for the uninstallation processing. The information received by the information communication module 105 from the maker server 200 includes response information, which permits the uninstallation processing, to the computer 100.

The information storage module 106 stores the information, which is received by the information communication module 105 from the maker server 200, and permits the uninstallation processing, onto the storage area of the computer 100. In addition, the information storage module 106 stores reinstallation lock information, which is received from the maker server 200, and prevents the application program, to which the uninstallation processing has been applied, from being reinstalled, onto the storage area. Note that there installation lock information is preferably stored onto the storage area of the computer 100 which is hard to be tampered.

The database 107 stores backups of the information permitting the uninstallation processing, the reinstallation lock information, and the like.

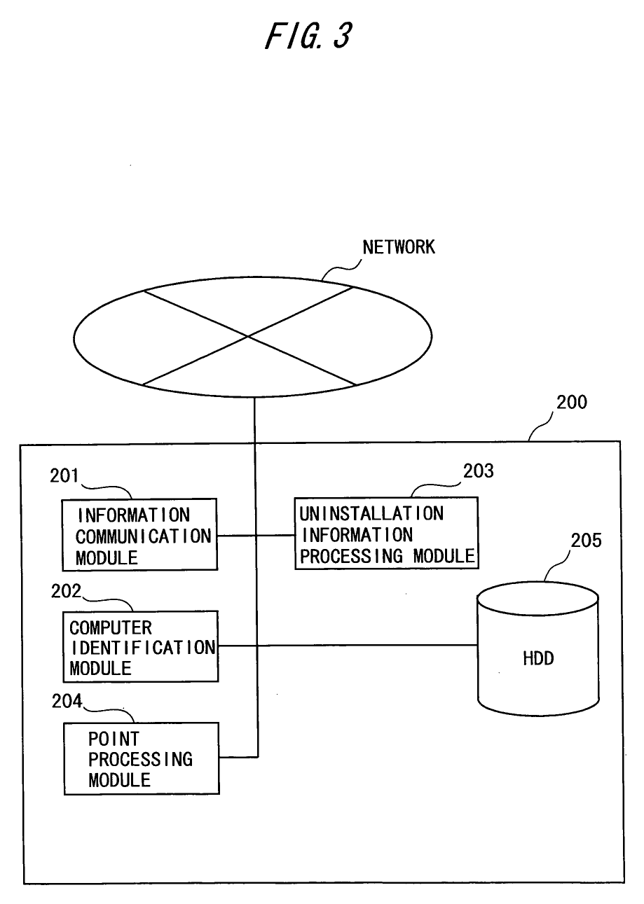

FIG. 3 is a block diagram showing the functions realized by the maker server 200. The maker server 200 is provided with an information communication module 201, a computer identification module 202, an uninstallation information processing module 203, a point processing module 204, and a database 205.

The information communication module 201 communicates the information required for the uninstallation processing with the computer 100. The information to be received by the information communication module 201 includes the information which can identify the computer 100 and the information requesting for the uninstallation processing transmitted by the computer 100. The information to be transmitted by the information communication module 201 includes the response information to the information requesting for the uninstallation processing transmitted from the computer 100 (information permitting the uninstallation processing) and the reinstallation lock information which does not permit the reinstallation after the uninstallation processing.

The computer identification module 202 identifies types, descriptions, and the like of the application programs preinstalled on the computer, which is requesting for the uninstallation processing, based on the information requesting for the uninstallation processing and the information which can identify the computer 100 transmitted by the computer 100 and received by the information communication module 201. In addition, the computer identification module 202 identifies whether the computer 100 requesting for the uninstallation processing is the computer 100 which has already been registered based on the information transmitted from the computer 100. Further, the computer identification module 202 identifies the user who uses the computer 100 based on the information transmitted from the computer 100. Then, the computer identification module 202 transmits information on the user and information on the application programs of the identified computer 100 to the uninstallation information processing module 203.

The uninstallation information processing module 203 stores information, which can identify the accomplishment of the uninstallation processing, onto the database 205 based on the information, which is processed by the computer identification module 202 after being transmitted from the computer 100. On this occasion, the uninstallation information processing module 203 updates the descriptions of the preinstalled programs of the computers 100, which are stored on the database 205 in such a manner as being divided by respective users, so as to indicate the accomplishment of the uninstallation processing.

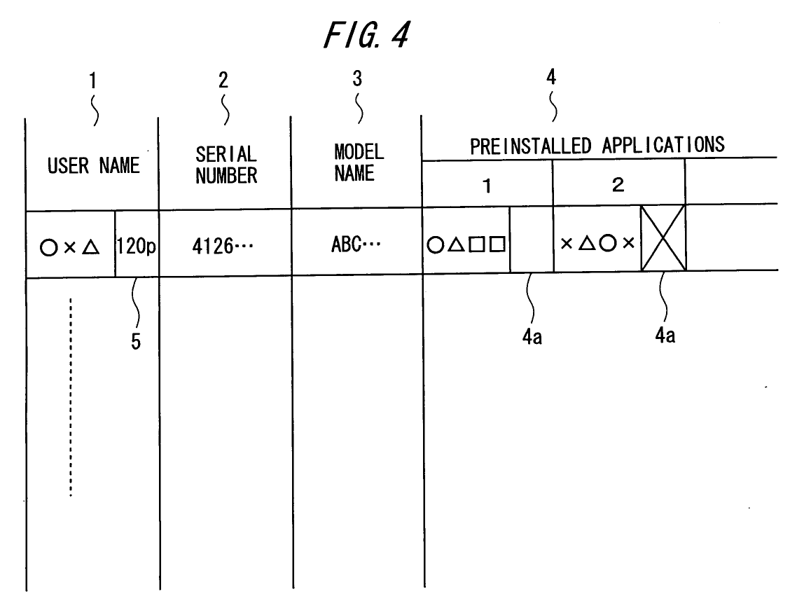

FIG. 4 is a diagram showing an example of the information on the preinstalled programs of the computer 100 of the user stored on the database 205. The database 205 has “User name” 1 of the computer 100, “Serial number” 2 of the computer 100, “Model name” 3 of the computer 100, and a list 4 of names of “Preinstalled programs” stored thereon. On the preinstalled program name list 4, an “x” mark is not placed on a checkbox 4a of the name of the preinstalled program for which the uninstallation processing has not been carried out. On the preinstalled program name list 4, however, the “x” mark is placed on a checkbox 4b of the name of the preinstalled program for which the uninstallation processing has been carried out. In this way, according to the presence/absence of the “x” mark on the check boxes 4a and 4b, the database 205 can identify whether the preinstalled programs are respectively uninstalled or not.

The point processing module 204 carries out the assignment of predetermined points according to the accomplishment of the uninstallation processing. Accumulated points for the respective users are recorded on a point record menu 5 on the database 205 shown in FIG. 4.

### EXAMPLE OF UNINSTALLATION PROCESSING

A description will now be given of an example of the uninstallation processing carried out according to the system constituted by the computer 100 and the maker server 200 with reference to flowcharts.

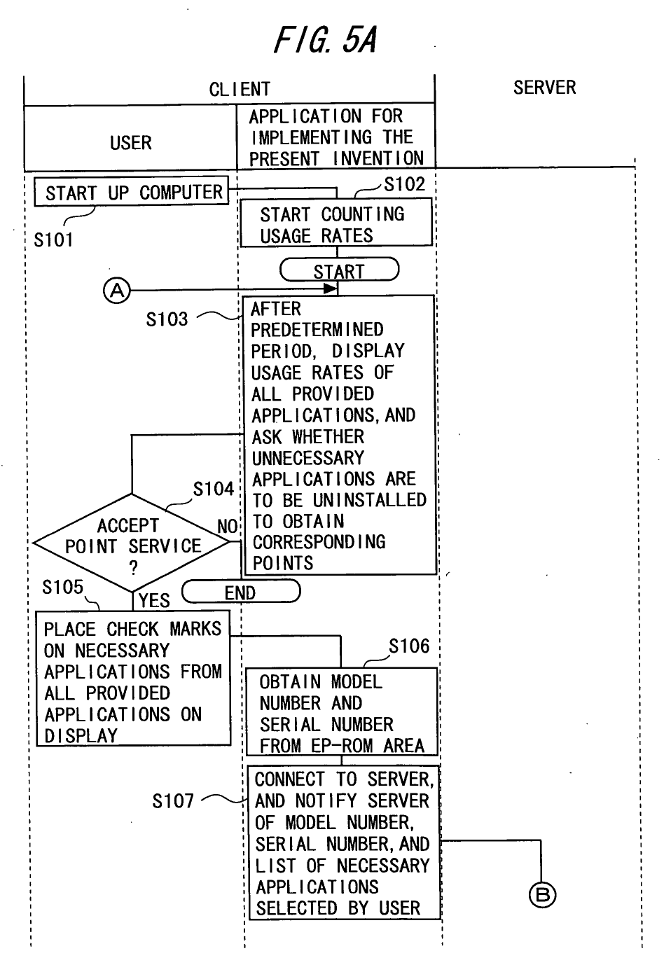

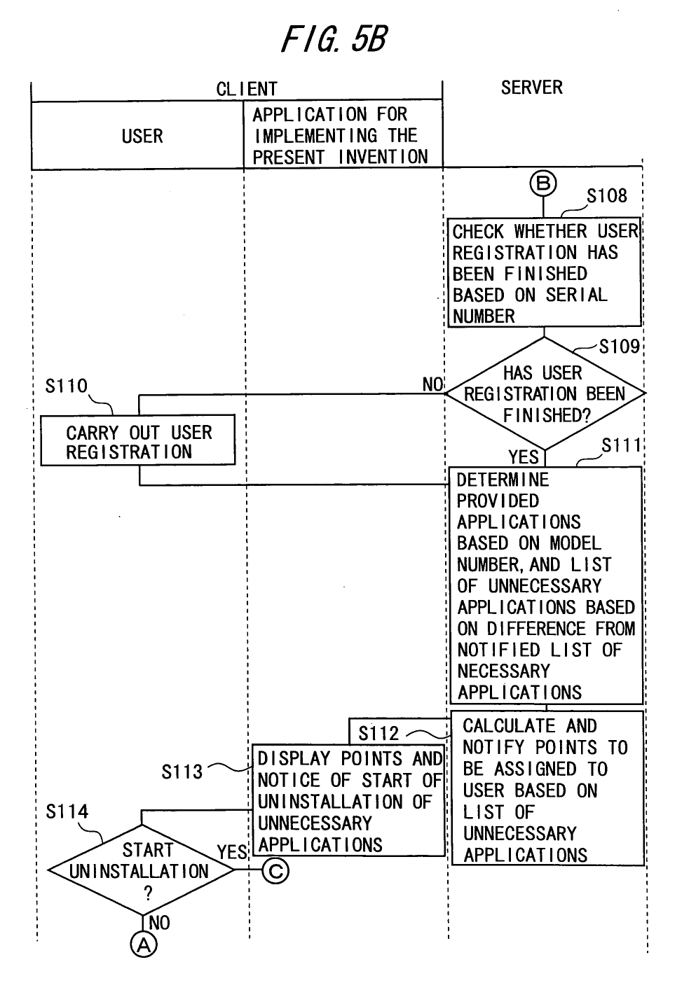

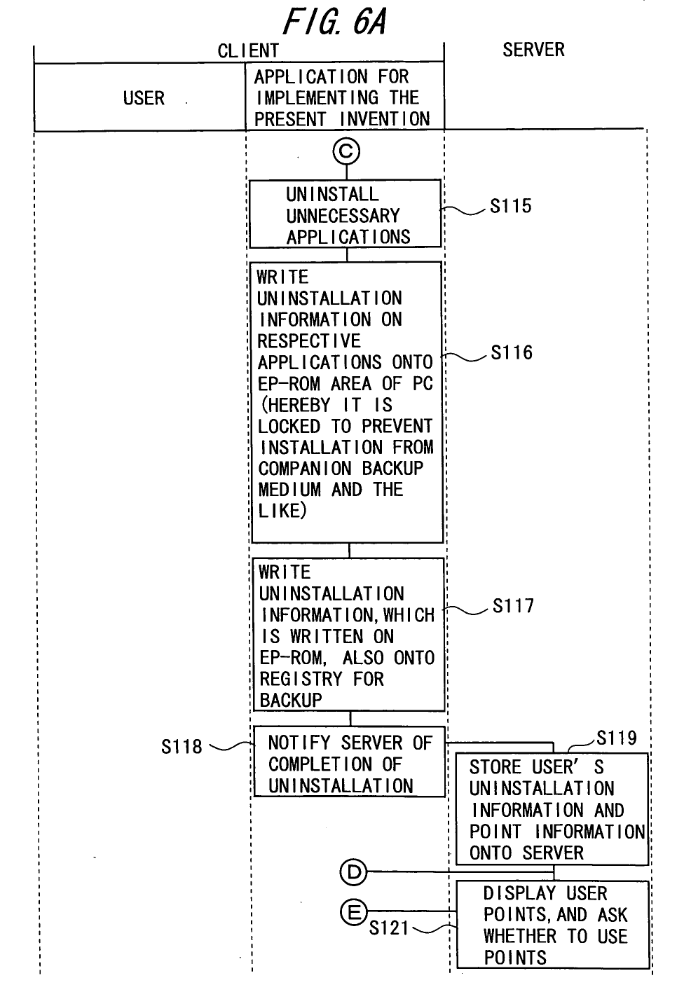

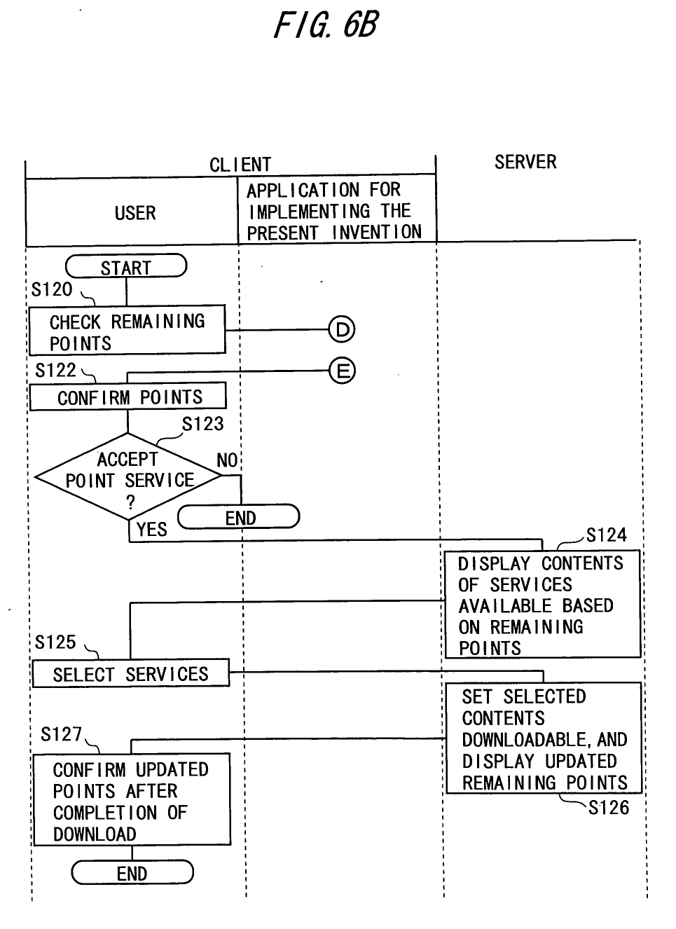

FIGS. 5 and 6 are the flowcharts of the uninstallation processing according to this system.

When the computer 100 is started up by an operation of the user (S101), the uninstallation processing program automatically starts up and starts the processing. The computer 100 starts the count (measurement) of startup frequencies (usage rates) of the preinstalled application programs (S102).

If a predetermined period has elapsed since the start of counting the usage rates of the application programs (after one month, for example), the computer 100 shows the usage rates of all of the installed (provided) application programs, and then asks the user for an instruction whether to carry out the uninstallation processing for the point exchange (S103).

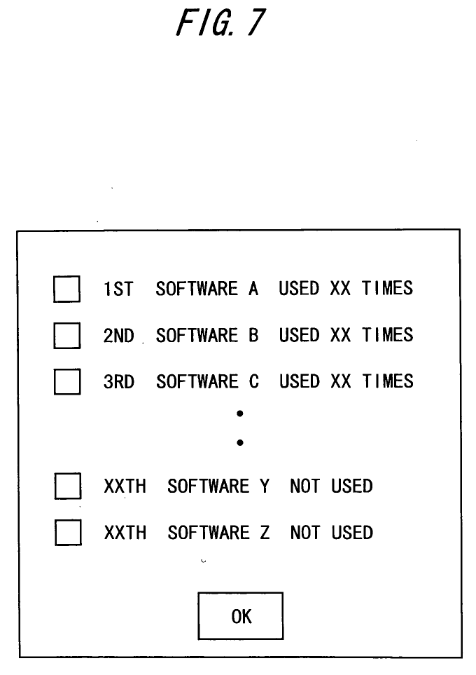

FIG. 7 is a ranking screen showing the usage rates of all of the application programs. The ranking screen displays the usage rates of all of the preinstalled application programs as a ranking (rank order indication) form.

The computer 100 asks the user to respond to whether to carry out the uninstallation processing in order to accept the point assignment (S104). If the user does not request for the point assignment, the computer 100 finishes the processing.

If the user requests for the point assignment, the computer 100 asks the user to select the application programs which the user intends to continue to use subsequently, through the ranking screen (S105).

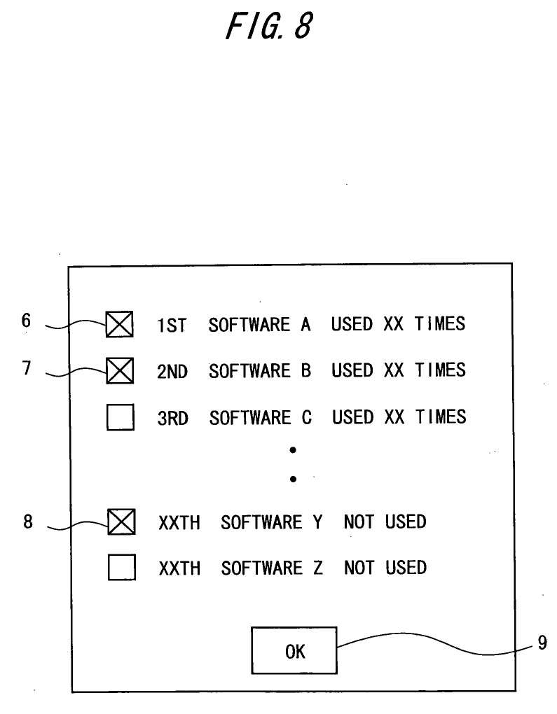

FIG. 8 is the ranking screen showing a state where the user has instructed the uninstallation processing. The “x” marks are attached to checkboxes 6, 7, and 8 according to an operation of the user on the ranking screen. Then, if the “OK” button 9 shown on the ranking screen is depressed by an operation of the user, the computer 100 continues the uninstallation processing.

When the computer 100 carries out the point assignment as a result of the uninstallation processing based on the instruction of the user, the computer 100 acquires the information which identifies the computer 100 such as the model number identifying the model name and the serial number from the predetermined area (such as the EP-ROM area) of the computer 100 (S106).

The computer 100 makes a connection to the maker server 200 through the network. The computer 100 then notifies the maker server 200 of the model number, the serial number, and types of the application programs for which the user requests for the uninstallation processing (S107).

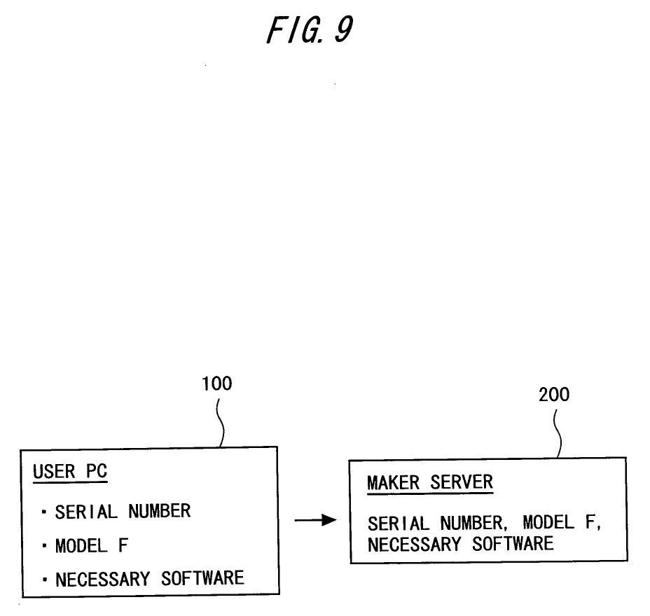

FIG. 9 is an illustration showing an example of the information on the computer 100 notified from the computer 100 to the maker server 200. The computer 100 of the user transmits, to the maker server 200, the information including the serial number, “Model F” (the model name identifying the type of the computer 100), and the necessary application programs (software).

The maker server 200, which has received the information from the computer 100, checks whether the user of the computer 100 corresponding to the serial number is a user registered to the maker server 200 (S108), (S109).

If it is determined that the user registration has not been finished yet based on the serial number, the maker server 200 notifies the computer 100 of information which urges the user registration. According to the information, the user carries out the user registration from the computer 100 to the maker server 200 (S110).

If it is determined that the user registration has been finished, the maker server 200 identifies the types of the programs preinstalled on the computer 100 according to the model number. The maker server 200 then identifies the types of the application programs for which the execution of the uninstallation processing and the point assignment are requested according to a difference between the list of the names of the preinstalled programs and the types of the application programs to which the check marks have been assigned (which are to be used) (S111).

The maker server 200 calculates the points assigned (offered) to the user according to the types of the application programs for which the uninstallation processing is to be carried out. The maker server 200 then notifies the computer 100 of the calculated points and instruction information to execute the uninstallation (S112).

The computer 100, which has been notified of the points from the maker server 200, shows the points on display output means such as the display. In addition, the computer 100 also shows that the uninstallation processing is to be carried out on the display or the like according to the instruction to execute the uninstallation processing (S113).

The computer 100 checks with the user as to whether to start the uninstallation processing or not (S114). On this occasion, if the uninstallation processing is not to be carried out, the computer 100 returns to S103 and go through process.

The computer 100 uninstalls the application programs no longer necessary according to the instruction to execute the uninstallation (S115).

The computer 100 stores the information on the uninstalled application programs onto the area hard to be rewritten (such as the EP-ROM) of the computer 100 after the uninstallation processing (S116). Since the information indicating the accomplished uninstallation of the application programs is stored onto the EP ROM, the computer 100 cannot reinstall these application programs.

In addition, the computer 100 records information, which is similar to the uninstallation information stored onto the EP-ROM, onto the registry area as a backup (S117). The computer 100 notifies the maker server 200 of the completion of the uninstallation processing (S118).

The maker server 200, which has been notified of the completion of the uninstallation processing, stores the uninstallation information and the point information on the user onto the database 205 (S119).

If the user uses the accumulated points in order to purchase articles and the like, the computer 100 checks information on the remaining points stored on the database 205 (S120).

The maker server 200, which has received the request for checking the remaining point information from the computer 100, transmits the remaining point information, which is to be displayed to the user, to the computer 100. In addition, the maker server 200 asks the user of the computer 100 whether to use the points or not (S121).

The user of the computer 100 confirms the remaining point information notified by the maker server 200 (S122). The computer 100 then asks the user whether to accept services using the points (S123).

If the user uses the point service, the maker server 200 displays contents of the services, which are available according to the remaining points of the user, on the computer 100 (S124)

The user uses the computer 100 to select desired service contents from the contents of the available services displayed by the maker server 200 (S125).

If the contents selected by the user correspond to downloadable images and the like, the maker server 200 sets the service contents to be downloadable. The maker server 200 then records a remainder of the points obtained by subtracting points corresponding to the service contents onto the database 205. After recording the remaining points, the maker server 200 shows the remainder information on the computer 100 (S126).

The computer 100 downloads data of the service contents. The computer 100 shows the remainder information after the subtraction to notify the user (S127).

### Effects of Embodiment

The computer 100 and the maker server 200 according to the embodiment of the present invention described above provide the following effects.

According to the computer 100, it is possible to provide the user with the uninstallation processing technology which can satisfy willingness to buy. In addition, according to the computer 100, it is possible to provide the technology which enables to precisely recognize the uninstallation processing of the application programs.

In addition, according to the maker server 200, it is possible to provide the technology which enables to precisely recognize the uninstallation processing of the application pr grams preinstalled on the computers of the users.

What is claimed is:

1. An uninstallation processing program for causing a computer to execute the steps of:
measuring an execution frequency of an application program for each of application programs executed by a computer;
displaying a measured execution frequency of each of the application programs;
transmitting information used for identifying an application program to be uninstalled, and information used for identifying the computer, to a server;
receiving information on permission for uninstallation, from the server;
uninstalling the application program; and
storing uninstallation information indicating that the application program has been uninstalled onto a storage area.

2. The uninstallation processing program according to claim 1 for further causing the computer to execute the step of making it impossible to execute reinstallation of the application program whose uninstallation information is stored on the storage area.

3. The uninstallation processing program according to claim 1, wherein the storage area is at least one of an EP-ROM area and a registry area of the computer.

4. An uninstallation management program for causing a computer to execute the step of:
receiving information used for identifying a computer, and information used for identifying an application program to be uninstalled, from the computer;
transmitting information on permission for the uninstallation based on the information used for identifying the application program to be uninstalled, to the computer; and
storing the information used for identifying the computer and information on the uninstalled application program.

5. The uninstallation management program according to claim 4 for further causing the computer to execute the steps of:
calculating point information assigned to the computer based on the information used for identifying the application program to be uninstalled;
transmitting the point information to the computer;
transmitting information on an article purchasable based on the point information to the computer;
receiving purchase request information on the article obtained based on the point information, from the computer;
transmitting the article corresponding to the purchase request information to the computer; and
transmitting point information obtained after purchasing article, to the computer.

6. A computer, comprising:
an execution frequency measurement unit measuring an execution frequency of an application program for each of application programs executed by a computer;
an execution frequency display unit displaying the measured execution frequency of each of the application programs;
an information transmitting unit transmitting information used for identifying an application program to be uninstalled, and information used for identifying the computer, to a server;
an information receiving unit receiving information on permission for uninstallation from the server;
an uninstallation processing unit uninstalling the application program; and
an information storage unit storing uninstallation information indicating that the application program has been uninstalled onto a storage area.

7. The computer according to claim 6, further comprising an uninstallation lock processing unit making it impossible to execute reinstallation of the application program whose uninstallation information is stored on the storage area.

8. The computer according to claim 6, wherein the storage area is at least one of an EP-ROM area and a registry area.

9. An uninstallation management device, comprising:
an information receiving unit receiving information used for identifying a computer, and information used for identifying an application program to be uninstalled, from the computer;
an information transmitting unit transmitting information on permission for the uninstallation based on the information used for identifying the application program to be uninstalled; and
an uninstallation information storage unit storing the information used for identifying the computer, and information on the uninstalled application program.

10. The uninstallation management device according to claim 9, further comprising a point information calculating unit calculating point information assigned to the computer based on the information used for identifying the application program to be uninstalled, wherein:
the information transmitting unit transmits the point information and information on an article purchasable based on the point information to the computer;
the information receiving unit receives purchase request information on the article obtained based on the point information, from the computer; and
the information transmitting unit transmits the article corresponding to the purchase request information and point information obtained after purchasing article, to the computer.
